(19) United States
(12) Patent Application Publication
(10) Pub. No.: US 2011/0083625 A1
(43) Pub. Date: Apr. 14, 2011

(54) Dual Function Crankcase Breather System

(75) Inventor: Timothy M. Lyons, Batavia, IL (US)

(73) Assignee: International Engine Intellectual Property Company, Warrenville, IL (US)

(21) Appl. No.: 12/577,741

(22) Filed: Oct. 13, 2009

(51) Int. Cl. F01M 13/00; F02B 25/06

(52) U.S. Cl. 123/41.86; 123/574; 123/573

(57) ABSTRACT

A breather system functions, during cold operation, as an open breather system, and functions as a closed breather system once the engine has sufficiently warmed. The breather system includes a first flow path between the engine crankcase and an air intake for the engine, and a three-way valve located within the flow path and responsive to ambient temperature and engine coolant temperature to close the conduit and to open a second flow path between the engine compartment and atmosphere.

### FIELD OF THE INVENTION

This invention relates to internal combustion engines, including but not limited to recirculation of crankcase gases into the intake system of an engine.

### BACKGROUND

The present invention relates to a closed loop breather system for a crankcase of an internal combustion engine of the type which recirculates piston blow-by gases in the crankcase to the intake air line of an engine to eliminate the discharge of oil mist into the environment and, more particularly, to a breather system which limits the pressure differential between the engine crankcase and atmosphere.

Ideally, the pressure within an internal combustion engine crankcase should be maintained at a level equal to or slightly less than atmospheric pressure to prevent external oil leakage through the various gasketed joints, such as that between the valve cover and the cylinder head. Combustion gases are generated during the operation of an internal combustion engine. A small amount of these gases leaks past the piston seals of the internal combustion engine, and unless the gases are removed from the crankcase, they become trapped. These gases, commonly referred to in the art as “blow-by” gases, need to be released. Because of the “blow-by” gases, the crankcase pressure will inherently rise, promoting leakage of oil from the crankcase. Originally, crankcase pressure was vented to the atmosphere through a breather to solve this problem.

Environmental considerations dictate that the blow-by gases in the crankcase be vented back to the combustion chamber rather than being released to the atmosphere. Accordingly, the crankcase was scavenged by being connected to the engine air intake thereby resulting in a vacuum in the crankcase with a depression valve being used to prevent the negative pressure in the engine cavity from exceeding a predetermined amount.

Government regulations require the engine to be within defined levels of exhaust emissions, including crankcase vapors, under specific environmental conditions which include ambient temperature and altitude. Outside of the specified environmental conditions, the “emissions window” the engine is allowed to have different emission levels.

The present inventors have recognized that during extreme cold weather operation, it is possible that water vapor in the combustion process captured in closed breather system can condense and can be detrimental to various engine components.

### SUMMARY

The exemplary embodiment of the invention provides a breather system that reduces the possibility of water vapor condensing on engine parts during cold weather operation while also meeting emissions requirements.

The exemplary system would function, during cold operation, as an open breather system, and function as a closed breather system once the engine has sufficiently warmed. The exemplary system provides a flexible, two function crankcase breather system that responds to ambient conditions.

An exemplary embodiment of the invention provides a breather system for an internal combustion engine that includes a first flow path between an engine compartment subject to blow-by gasses and an air intake for the engine, and a valve located within the flow path and responsive to at least one of an ambient temperature condition and a coolant temperature condition to close the conduit and to open a second flow path between the engine compartment and atmosphere.

The system includes an ambient temperature sensor and a coolant temperature sensor. The valve is responsive to both the ambient temperature sensor and the coolant temperature sensor.

The system can comprise a control unit and a valve actuator operatively connected to the valve to change flow paths through the valve upon command. The actuator is signal-connected to the control unit, and the ambient temperature sensor and the coolant temperature sensor are signal-connected to the control unit. The control unit determines a command to the actuator depending on ambient temperature and coolant temperature.

An exemplary method of the invention for operating an internal combustion engine includes the steps of:

sensing an engine temperature;

providing the breather system can be operated as a closed breather system connecting an engine compartment subject to blow-by gasses and an air intake of the engine, or an open breather system connecting the engine compartment subject to blow-by gasses and atmosphere; and

if engine temperature is below a predetermined low engine temperature threshold, operating the breather system as the open breather system, and when the engine temperature exceeds the predetermined low engine temperature threshold operating the breather system as the closed breather system.

Alternately, the method of operating an internal combustion engine includes the steps of:

sensing an engine temperature;

sensing an ambient temperature;

providing the breather system can be operated as a closed breather system connecting an engine compartment subject to blow-by gasses and an air intake of the engine, or an open breather system connecting the engine compartment subject to blow-by gasses and atmosphere; and

if engine temperature is below a predetermined low engine temperature threshold, and if ambient temperature is below a predetermined low ambient temperature threshold, operating the breather system as the open breather system, and when the engine temperature exceeds the predetermined low engine temperature threshold or if the ambient temperature exceeds the low ambient temperature threshold, operating the breather system as the closed breather system.

The step of sensing engine temperature can be accomplished by sensing engine coolant temperature.

Numerous other advantages and features of the present invention will be become readily apparent from the following detailed description of the invention and the embodiments thereof, from the claims and from the accompanying drawings.

### BRIEF DESCRIPTION OF THE DRAWINGS

FIG. 1 is a plan view of a turbocharged engine and shows schematically a crankcase breather system of the present invention engaged to and between a valve housing of the engine and the compressor air inlet line of a turbocharger; and

FIG. 2 is a schematic diagram of a dual function crankcase breather system of the present invention.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

Referring now to the drawings in greater detail, there is illustrated therein a dual function engine crankcase breather system of the present invention generally identified by the reference numeral 10 mounted on an internal combustion engine 18, preferably a diesel engine.

The breather system 10 comprises a breather tube assembly 12 having an inlet end 14 in fluid communication with the interior of a valve housing or rocker arm cover 16 of engine 18 and an outlet end 20 (FIG. 2) in fluid communication with a pitot tube fitting 13 mounted on an intake air line 22 of the engine 18 and extending therewithin. When the engine 18 is turbocharged as shown, pitot tube fitting 13 is located in the compressor air inlet line to the turbocharger 24. In a naturally aspirated engine, the pitot tube would be located in the intake air passage from the air cleaner.

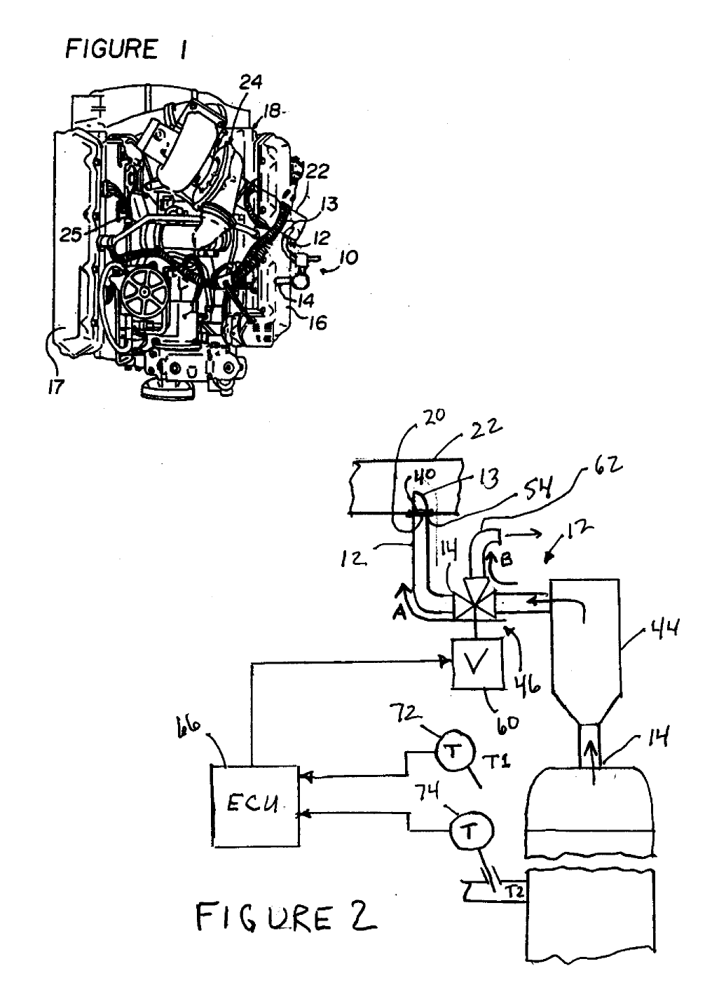

In a V-8 engine, such as shown in FIG. 1, a crossover tube 25 interconnects the valve housing 16 with the rocker arm cover 17 of the other bank of the engine to equalize the pressure throughout the engine. It will be understood that the rocker arm cover 16 defines a portion of a closed interior cavity of the engine and that there is a continuous internal air path existing within and between the crankcase and the rocker arm cover 16. Thus, venting of the valve housing 16 will necessarily vent the interior of the crankcase as well as valve housing 17.

The pitot tube 13 includes an opening 40. A complete description of the arrangement and structure of the pitot tube 13 can be found in U.S. Pat. No. 5,140,968, herein incorporated by reference.

The breather tube assembly 12 includes an oil mist separator 44 connected to the inlet end 14, and a dual function selection valve 46 connected to the separator 44. The dual function selection valve 46 is connected to an outlet tube 50 which is connected to the pitot tube 13 via a fitting 54.

The separator 44 can be configured as described in U.S. Pat. No. 7,185,643, herein incorporated by reference.

The dual function selection valve 46 can be a three-way valve that is acted on by an electrically controlled solenoid actuator 60. Alternately, the actuator can be an electrically controlled and vacuum operated valve.

The state or position of the valve 46 either allows engine gas to pass into the intake air line 22 of the engine 18 according to a path marked “A” or pass directly to atmosphere through an outlet tube 62 according to a path marked “B”. Depending on a signal from the engine control module or unit (ECU) 66, the actuator 60 changes the state of the valve to either pass engine gases through the path “A” while closing the path “B” or pass engine gases through the path “B” while closing the path “A”. The path “A” corresponds to a closed breather system, and the path “B” corresponds to an open breather system.

In order for the ECU 66 to automatically select the path “A” or “B”, the ECU 66 receives and evaluates two temperature signals. A first temperature signal is received from an ambient temperature sensor 72 that measures ambient temperature T1. A second temperature signal is received from a coolant temperature sensor 74 that measures coolant temperature T2 within the engine block or just after the coolant exits the engine block cooling jackets.

When the temperature of the coolant T2 sensed by the sensor 74 exceeds a predetermined coolant cold temperature limit Tc2, for example Tc2 being about 50 degrees F., the path “A” is automatically selected by the ECU 66 and the actuator 60 changes the position of the valve 46 to the position corresponding to the path “A” or if the path “A” is already selected, the ECU 66 maintains that configuration. This configuration corresponds to a closed breather system.

During cold ambient conditions, when the temperature sensor T1 senses an ambient temperature T1 below a predetermined ambient cold temperature limit Tc1, for example Tc1 being about 20 degrees F., and the temperature of the coolant T2 is below the predetermined coolant cold temperature limit Tc2, the ECU 66 selects the path “B” and the configuration is set to be an open breather system. Once the engine warms up to where the coolant temperature T1 is above Tc2, the ECU 66 commands the actuator 60 to change the position of the valve 46 to the path “A” regardless of the ambient temperature.

If the ambient temperature T1 is above the cold temperature limit Tc1 the ECU 66 commands the actuator 60 to change the position of the valve 46 according to the “A” path, or maintains the valve 46 according to the “A” path, regardless of the coolant temperature T1.

From the foregoing, it will be observed that numerous variations and modifications may be effected without departing from the spirit and scope of the invention. It is to be understood that no limitation with respect to the specific apparatus illustrated herein is intended or should be inferred.

The invention claimed is:

1. A breather system for an internal combustion engine comprising:
a first flow path between an engine compartment subject to blow-by gasses and an air intake for the engine; and
a valve located within the first flow path and responsive to at least one of ambient temperature and coolant temperature to close the conduit and to open a second flow path between the engine compartment and atmosphere.

2. The system according to claim 1, comprising an ambient temperature sensor and a coolant temperature sensor and wherein the valve is responsive to both the ambient temperature sensor and the coolant temperature sensor.

3. The system according to claim 2, comprising a control unit and a valve actuator operatively connected to the valve to change flow paths through the valve upon command, and the actuator being signal-connected to the control unit, and the ambient temperature sensor and the coolant temperature sensor being signal-connected to the control unit, the control unit determining a command to the actuator depending on ambient temperature and coolant temperature.

4. The system according to claim 3, further comprising an oil mist separator located within the first flow path.

5. The system according to claim 4, wherein the oil mist separator is located also within the second flow path.

6. The system according to claim 1, further comprising an oil mist separator located within the first flow path.

7. The system according to claim 6, wherein the oil mist separator is located also within the second flow path.

8. A method of operating an internal combustion engine, comprising the steps of:
sensing an engine temperature;
providing the breather system can be operated as a closed breather system connecting an engine compartment subject to blow-by gasses and an air intake of the engine, or an open breather system connecting the engine compartment subject to blow-by gasses and atmosphere; and
if engine temperature is below a predetermined low engine temperature threshold, operating the breather system as the open breather system, and when the engine temperature exceeds the predetermined low engine temperature threshold operating the breather system as the closed breather system.

9. The method according to claim 8, wherein the step of sensing engine temperature is further defined in that the engine coolant temperature is sensed.

10. The method according to claim 9, comprising the further step of separating oil mist within the open breather system.

11. The method according to claim 10, comprising the further step of separating oil mist within the closed breather system.

12. A method of operating an internal combustion engine, comprising the steps of:
sensing an engine temperature;
sensing an ambient temperature;
providing the breather system can be operated as a closed breather system connecting an engine compartment subject to blow-by gasses and an air intake of the engine, or an open breather system connecting the engine compartment subject to blow-by gasses and atmosphere; and
if engine temperature is below a predetermined low engine temperature threshold, and if ambient temperature is below a predetermined low ambient temperature threshold, operating the breather system as the open breather system, and when the engine temperature exceeds the predetermined low engine temperature threshold or if the ambient temperature exceeds the low ambient temperature threshold, operating the breather system as the closed breather system.

13. The method according to claim 12, wherein the step of sensing engine temperature is further defined in that the engine coolant temperature is sensed.

14. The method according to claim 13, comprising the further step of separating oil mist within the open breather system.

15. The method according to claim 14, comprising the further step of separating oil mist within the closed breather system.
